(19) United States
(12) Patent Application Publication
(10) Pub. No.: US 2019/0007851 A1
(43) Pub. Date: Jan. 3, 2019

(54) SDN-BASED MULTIPLE WIRELESS NETWORK INTEGRATION SYSTEM AND METHOD THEREFOR

(71) Applicant: KWANGWOON UNIVERSITY INDUSTRY ACADEMIC COLLABORATION FOUNDATION, Seoul (KR)

(72) Inventor: Hyuk Joon LEE, Seoul (KR)

(73) Assignee: KWANGWOON UNIVERSITY INDUSTRYACADEMIC COLLABORATION FOUNDATION, Seoul (KR)

(21) Appl. No.: 15/745,263

(22) PCT Filed: Nov. 15, 2015
(86) PCT No.: PCT/KR2015/012918

§ 371 Date: Jan. 16, 2018

(30) Foreign Application Priority Data
Jul. 15, 2015 (KR) 10-2015-0100506

(51) Int. Cl. H04W 24/08; H04W 48/18

(52) U.S. Cl. CPC H04W 24/08; H04W 84/12; H04W 48/18

(57) ABSTRACT

Provided is a multiple wireless network integration system and method. A software defined network (SDN) switch is connected to at least two or more networks to monitor traffic information of each network, an SDN controller provides the SDN switch with forwarding table information generated by using packet information received from the SDN switch and receives the traffic information of each network from the SDN switch to generate high-level traffic information, and an information server receives the high-level traffic information from the SDN controller to generate network state information and then detects state information of a plurality of networks accessible to a terminal and provides the detected state information to the terminal.

### TECHNICAL FIELD

The present disclosure relates to multiple wireless network integration systems and methods, and more particularly, to multiple wireless network integration systems and methods in which, by using the software defined network (SDN) technology, according to the network states, a terminal capable of simultaneously connecting to a plurality of wireless access networks may select a transmission and reception interface for each flow to achieve the offload of a mobile communication (cellular) network.

The present disclosure is derived from the research supported by the MIST, Korea, under the National Program for Excellence in SW supervised by the IIT P″(2017-0-00096).

### BACKGROUND ART

In the case of communicating by using 3rd Generation (3G) or Long Term Evolution (LTE) wireless communication technology, since data passes through a core network of a mobile communication company, the load on the core network increases as the data traffic thereof increases. There are various technologies for distributing the load on a core network, and among them, traffic offloading is a technology for distributing a portion of traffic through a WiFi network that is separate from the core network.

An Integrated Femto-WiFi (IFW) network is a network as a combination of FemtoCell and WiFi based on the broadband Internet, and an IFW gateway may be installed at a point where a femtocell network and a WiFi network connect to the external Internet, to integrate and manage two networks to perform traffic offloading. Since both FemtoCell and WiFi have small communication radiuses, they may be used to reduce the overload on a mobile communication core network in a small cell-based environment such as a home network or an enterprise network.

In the case of performing simultaneous transmission through two networks in an IFW network by using a terminal equipped with multiple wireless network interfaces, an algorithm for determining which interface to use to transmit the traffic to be transmitted may be important.

In the conventional multiple interface selection and parallel transmission technology, research has been conducted in the direction of selecting an optimal interface by using the information measured in a terminal, or optimizing the transmission control protocol (TCP) originally designed for single interface systems to such that multiple interfaces are used simultaneously. However, the conventional multiple interface selection technology has a limitation in that it may not base its selection on the overall traffic condition of a network and depends only on the measured or estimated values of traffic-related state variables in a terminal.

### DETAILED DESCRIPTION OF THE INVENTION

### Technical Problem

The present disclosure is to provide multiple wireless network integration systems and methods in which a terminal connectable to a plurality of networks may select an optimal network for each flow according to the network states and perform simultaneous transmission/reception to achieve the offload of a mobile communication network.

### Technical Solution

According to an embodiment of the present disclosure, a multiple wireless network integration system includes: a software defined network (SDN) switch connected to at least two or more networks to monitor traffic information of each network; an SDN controller providing the SDN switch with forwarding table information generated by using packet information received from the SDN switch and receiving the traffic information of each network from the SDN switch to generate high-level traffic information; and an information server receiving the high-level traffic information from the SDN controller to generate network state information and providing a terminal with a plurality of network state information accessible to the terminal or optimal network selection information detected based on the plurality of network state information.

According to another embodiment of the present disclosure, a terminal for multiple wireless network integration includes: a network state information receiving unit requesting and receiving optimal network selection information or state information about a plurality of available networks from an information server; a network selecting unit selecting one of the plurality of networks based on the optimal network selection information or the network state information; and an interface unit transmitting/receiving packets through the selected network on a flow-by-flow per-flow basis.

According to another embodiment of the present disclosure, a method for multiple wireless network integration in an SDN switch connected to a plurality of networks includes: switching packets received from the plurality of networks based on forwarding table information received from an SDN controller; monitoring traffic information about each of the plurality of networks; and transmitting the traffic information to the SDN controller.

According to another embodiment of the present disclosure, a method for multiple wireless network integration in an information server providing state information of a plurality of networks includes: receiving high-level traffic information from an SDN controller generating the high-level traffic information by using traffic information monitored through an SDN switch; generating network state information by using the high-level traffic information received from the SDN controller or generating optimal network selection information for a terminal based on the network state information; and providing the terminal with the optimal network selection information or state information about at least two or more networks accessible to the terminal.

According to another embodiment of the present disclosure, a method for multiple wireless network integration in a terminal connectable to at least two or more networks includes: detecting a plurality of accessible network identification information; transmitting a network state information request including the network identification information to an information server and receiving network state information or optimal network selection information from the information server; selecting one of a plurality of accessible networks with respect to each flow based on the network state information or the optimal network selection information; and transmitting/receiving packets through the selected network on a flow-by-flow basis.

### Advantageous Effects of the Invention

According to the present disclosure, a user terminal may transmit/receive data by selecting an optimal network for each flow according to the network situation. Also, since data or the like is transmitted through the Internet or the like instead of a mobile communication core network according to the network situation, the load on the mobile communication core network may be reduced. Also, network traffic information may be easily collected by using the SDN technology.

### DESCRIPTION OF THE DRAWINGS

FIG. 1 is a diagram illustrating an example of an overall structure of a multiple wireless network integration system according to the present disclosure.

FIG. 2 is a diagram illustrating an example of a configuration of a terminal for multiple wireless network integration according to the present disclosure.

FIG. 3 is a diagram illustrating an example of a multiple wireless network integration method in a software defined network (SDN) switch according to the present disclosure.

FIG. 4 is a diagram illustrating an example of a forwarding table information providing method in an SDN controller according to the present disclosure.

FIG. 5 is a diagram illustrating an example of a multiple wireless network integration method in an SDN controller according to the present disclosure.

FIG. 6 is a diagram illustrating an example of a multiple wireless network integration method in an information server according to the present disclosure.

FIG. 7 is a diagram illustrating an example of a multiple wireless network integration method in a terminal according to the present disclosure.

### MODE OF THE INVENTION

Hereinafter, multiple wireless network integration systems and methods according to the present disclosure will be described in detail with reference to the accompanying drawings.

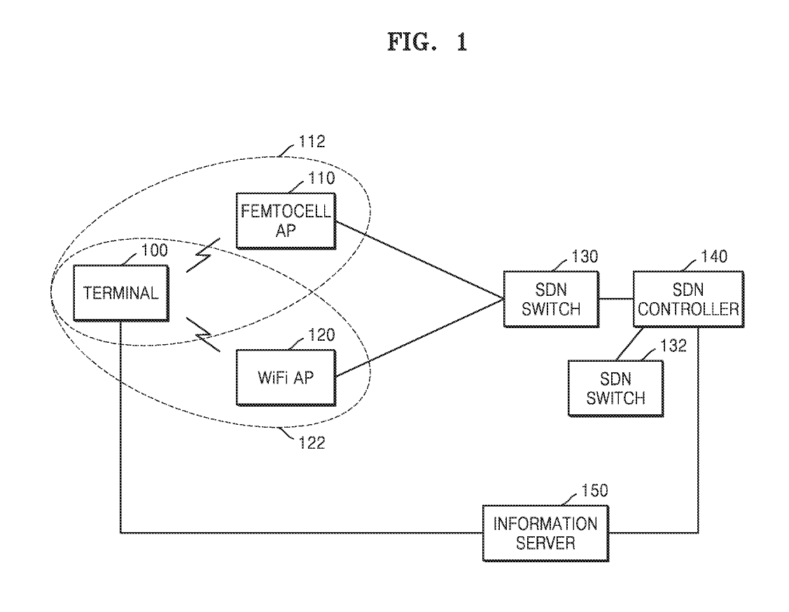

FIG. 1 is a diagram illustrating an example of an overall structure of a multiple wireless network integration system according to the present disclosure.

Referring to FIG. 1, the multiple wireless network integration system may include software defined network (SDN) switches 130 and 132, an SDN controller 140, and an information server 150.

The SDN switches 130 and 132 may be connected to a plurality of networks 110 and 120 as SDNs, and may switch the packets received from the networks 110 and 120 with reference to a forwarding table. Herein, the plurality of networks 110 and 120 may include a network connected to a femtocell access point (AP) 110 passing through a mobile communication network such as 3rd Generation (3G) or Long Term Evolution (LTE) or a network connected to a Wireless Fidelity (WiFi) AP 120 not passing through a mobile communication core network.

The SDN switches 130 and 132 may implement network virtualization and may transmit the packets received through a mobile communication network to a data network or transmit the packets received from the data network to the mobile communication network. However, when packets of a plurality of user terminals are concentrated on the mobile communication network, there may be a limitation in performing the offload of the mobile communication network by using only the SDN switches 130 and 132. Thus, as will be described below, the present embodiment may increase the efficiency of the offload by allowing the terminal to actively select an optimal network.

The SDN switches 130 and 132 may analyze each received packet to monitor traffic information such as the number of transmitted/received packets, the number of bytes, the number of lost packets, the delay time, and the traffic amount with respect to each network, and provide the results thereof to the SDN controller 140. For example, the SDN switches 130 and 132 may generate first traffic information detected by monitoring the number of packets transmitted/received from the femtocell AP 110 and second traffic information detected by monitoring the number of packets transmitted/received from the WiFi AP 120. In the present embodiment, although only one femtocell AP 110 and one WiFi AP 120 are illustrated for convenience of description, there may actually be a plurality of femtocell APs and WiFi APs and a plurality of Internets or mobile communication relays. Thus, in the present embodiment, “traffic information” may represent information obtained by monitoring packets transmitted/received from various APs or relays connected to the SDN switch. Also, the traffic information monitored by the SDN switches 130 and 132 may include various types of information other than the number of transmitted/received packets.

The SDN controller 140 may be connected to at least one or more SDN switches 130 and 132. When receiving the packet information from each of the SDN switches 130 and 132, the SDN controller 140 may detect an optimal path of the packet to generate forwarding table information and provide the same to the SDN switches 130 and 132. For example, when there is no forwarding information about the received packet in a local forwarding table, the SDN switches 130 and 132 may provide information about the packet to the SDN controller 140, and the SDN controller 140 may detect an optimal path of the packet to update the forwarding table information and transmit the same to the SDN switches 130 and 132. Since a method in which the SDN controller 140 are connected to the plurality of SDN switches 130 and 312 to detect an optimal path for the packet and generate or update the forwarding table information may be accomplished through various conventional methods, detailed description thereof will be omitted for conciseness.

The SDN controller 140 may receive and store the traffic information of each network from the SDN switches 130 and 132. The SDN controller 140 may request and receive the traffic information from the SDN switches 130 and 132 periodically or as necessary, or the SDN switches 130 and 132 may provide the traffic information to the SDN controller 140 periodically or in the case of a change in the traffic information (e.g., the case where the packet transmission/reception amount of each network or each flow corresponds to a predetermined condition). The SDN switches 130 and 132 and the SDN controller 140 may transmit/receive control signals or traffic information by using the south bound protocol. The SDN controller 140 may generate high-level traffic information by using the traffic information received from the SDN switches 130 and 132 and provide the high-level traffic information to the information server 150. Herein, the high-level traffic information may be a value calculated by using the traffic information and may include a transmission rate, a delay time, and/or a transmission success rate that is information representing a general network.

The SDN switches 130 and 132 and the SDN controller 140 may be located in a local network or a mobile communication network. In this case, a separate information server 150 may be provided in consideration of a security problem or a load increase that may be caused when the SDN controller 140 directly provides the situation information of the network to a terminal 100. The SDN controller 140 may transmit the high-level traffic information of the network to the information server 150 by using the north bound protocol.

The information server 150 may receive the high-level traffic information of each network from the SDN controller 140 and process the same into network state information. Then, the information server 150 may provide the network state information to the terminal 100. Herein, the network state information may be information calculated and used to select an interface of the terminal by using the high-level traffic information and may represent information processed for use in a network selection algorithm, not simple network information. The information server 150 may provide the network state information to the terminal 100 in an eXtensible Markup Language (XML) or JavaScript Object Notation (JSON) format by using a Representational State Transfer (REST)-based Application Program Interface (API).

The terminal 100 may search and detect a currently-accessible peripheral network. For example, when the terminal 100 is located in an overlap between communication regions 112 and 122 of the femtocell AP 110 and the WiFi AP 120, the terminal 100 may transmit/receive packets through the femtocell AP 110 or the WiFi AP 120. In the case of occurrence of flow, in order to select an optimal network among a plurality of networks for each flow, the terminal 100 may transmit the identification information of accessible networks (e.g., identification information of a femtocell AP and a WiFi AP) to the information server 150 and receive the network state information corresponding to the network identification information from the information server 150. Then, the terminal 100 may transmit/receive packets by selecting an optimal network based on the received network state information.

The terminal 100 may perform an optimal network selection on a flow-by-flow basis. For example, assume that the terminal 100 communicates data with a server A, communicates data with a server B, or communicates data with a terminal C. In this case, the terminal 100 may select an optimal network for the data communication with each of the server A, the server B, and the terminal C. The terminal 100 may select the WiFi AP 120 as the optimal network for the packet flow with the server A and the server B and select the femtocell AP 110 as the optimal network for the packet flow with the terminal C. Thus, the terminal 100 may perform packet transmission/reception in parallel through a plurality of networks on a flow-by-flow basis.

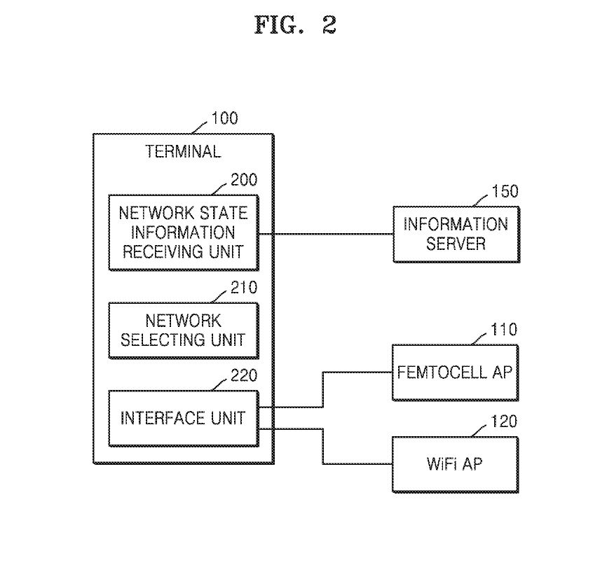

FIG. 2 is a diagram illustrating an example of a configuration of a terminal for multiple wireless network integration according to the present disclosure.

Referring to FIG. 2, the terminal 100 may include a network state information receiving unit 200, a network selecting unit 210, and an interface unit 220.

The interface unit 220 may include a communication module for communicating data with each of the plurality of networks 110 and 120. For example, the interface unit 220 may include a module for communication with a 3G or LTE femtocell and a communication module for WiFi.

The interface unit 220 may detect identification information of a network accessible to the terminal. For example, when the terminal 100 is located in the communication region of the femtocell AP 110 and the WiFi AP 120 and is connectable to both the femtocell AP 110 and the WiFi AP 120, the interface unit 220 may receive a network identifier from the femtocell AP 110 and the WiFi AP 120.

The network state information receiving unit 200 may transmit a network state information request message including the identifier of the accessible network detected through the interface unit 220 to the information server 150. The information server 150 may search for network prestored state information of each network based on the network identifier included in the network state information request message and provide the network state information to the terminal 100. The network state information receiving unit 200 may receive the network state information from the information server 150 through an REST API.

The network state information receiving unit 200 may request the network state information whenever a new flow needs to be generated. For example, when the terminal 100 needs to communicate with the server B while communicating with the server A, the terminal 100 may request the network state information from the information server 150 for optimal network selection for a packet flow to the server B.

The network selecting unit 210 may select an optimal network for each flow based on the network state information for each network received from the information server 150 through the network state information receiving unit 200. As an example of FIG. 1, the network state information receiving unit 200 may receive the network state information about the femtocell 112 and the WiFi 122, and the network selecting unit 210 may select a better network among the femtocell and the WiFi based on the received network state information. A network selection criterion may be variously set according to embodiments. For example, an optimal network may be selected based on the traffic amount or the delay time for each network. When receiving a message including the network state information of an XML or JSON format by using the REST API, the network selecting unit 210 may parse the message of an XML or JSON format to detect the network state information and then select an optimal network based on the detected network state information.

The network selecting unit 210 may select an optimal network on a flow-by-flow basis. For example, the network selecting unit 210 may select the femtocell AP 110 for the packet flow with the server A and select the WiFi AP 120 for the packet flow with the server B. Accordingly, the terminal 100 may transmit/receive packets in parallel on a flow-by-flow basis, thus achieving more efficient offloading of the mobile communication network.

The interface unit 220 may transmit/receive packets by using a communication module for the network selected by the network selecting unit 210. When the optimum network is selected on a flow-by-flow basis, the interface unit 220 may transmit/receive packets in parallel through the selected network for each flow according to which flow the packets belong to. For example, the interface unit 220 may transmit a packet of a flow A and a packet of a flow B in parallel through the femtocell AP 110 and the WiFi AP 120 respectively.

In the above embodiment of FIG. 2, the terminal may perform an optimal network selection process based on the network state information received from the information server 150. However, as another example, the information server 150 or the SDN controller 140 may perform an optimal network selection process for the terminal 100 and provide the selection result thereof to the terminal 100, and the terminal 100 may select a network according to the optimum network selection result received from the SDN controller 140.

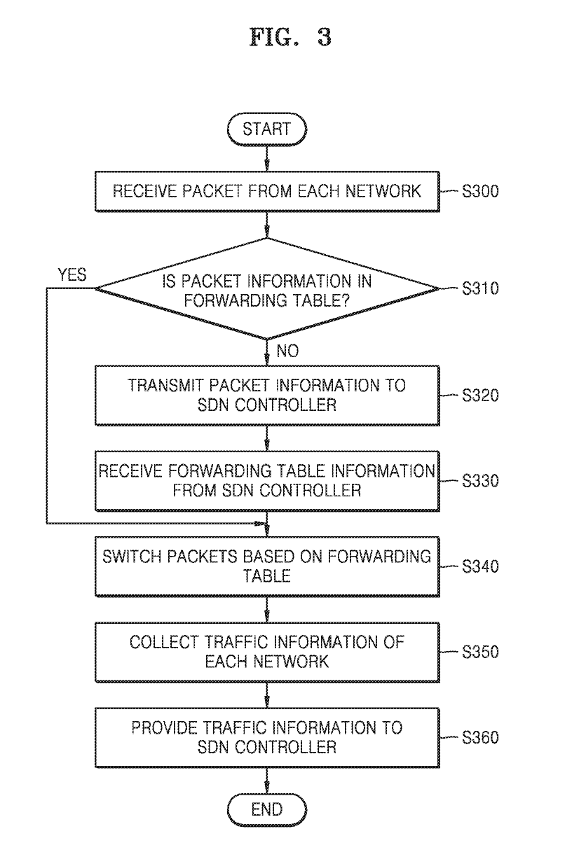

FIG. 3 is a diagram illustrating an example of a multiple wireless network integration method in an SDN switch according to the present disclosure.

Referring to FIG. 3, the SDN switch may receive a packet from each network (S300). When forwarding table information of the packet is in a forwarding table (S310), the SDN switch may switch packets based on the forwarding table (S340). On the other hand, when there is no forwarding table information about the packet (S310), the SDN switch may transmit the packet information to the SDN controller (S320) and receive the forwarding table information for the packet from the SDN controller (S330).

The SDN switch may monitor the packet switching process to detect traffic information such as the number of transmitted/received packets and the number of lost packets with respect to each network (or each flow) (S350). Then, the SDN switch may provide the traffic information of each network to the SDN controller (S360).

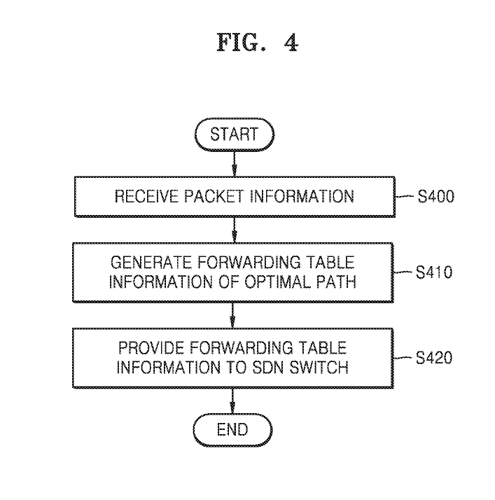

FIG. 4 is a diagram illustrating an example of a forwarding table information providing method in an SDN controller according to the present disclosure.

Referring to FIG. 4, when the SDN controller receives packet information from the SDN switch (S400), the SDN controller may detect an optimal path of the packet and update the forwarding table information accordingly (S410). Then, the SDN controller may provide the forwarding table information to the SDN switch (S420).

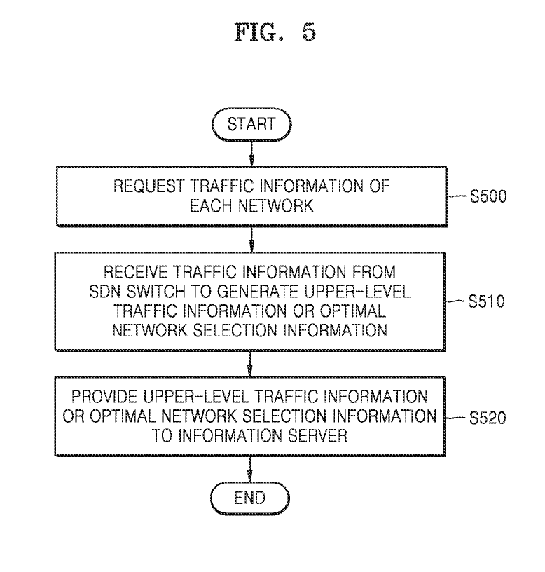

FIG. 5 is a diagram illustrating an example of a multiple wireless network integration method in an SDN controller according to the present disclosure.

Referring to FIG. 5, the SDN controller may request traffic information of each network from the SDN switch (S500). Then, the SDN controller may store the traffic information received from the SDN switch in a local database or the like (S510), and process the same into high-level traffic information and provide the high-level traffic information to the information server (S520).

As another example, the SDN controller may search the local database based on the network identifier included in the network state information request message of the terminal to detect the state information of the network, and select an optimal network for the terminal based on the detected state information of the terminal and then provide the selection result thereof to the terminal.

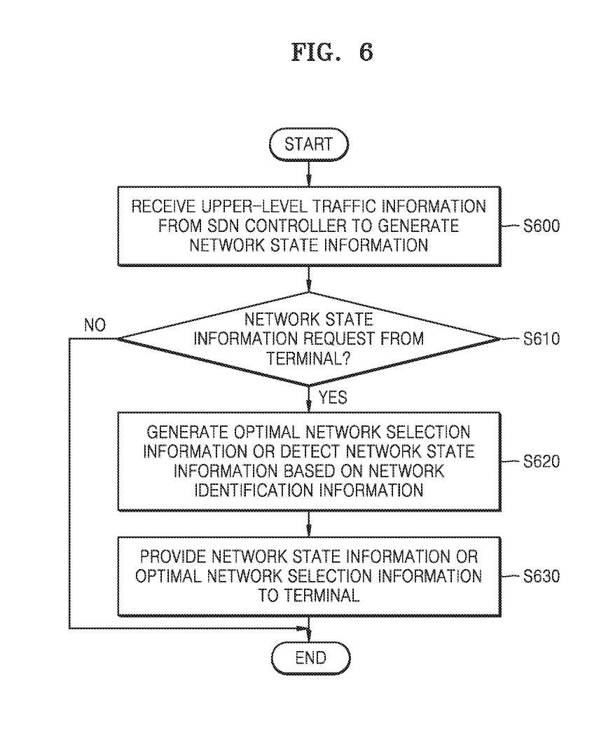

FIG. 6 is a diagram illustrating an example of a multiple wireless network integration method in an information server according to the present disclosure.

Referring to FIG. 6, the information server may receive high-level traffic information of each network from the SDN controller and store the received high-level traffic information locally (S600), and process the same into network state information. When the information server receives a network state information request message from the terminal (S610), the information server may search a local database based on the network identifier included in the network state information request message to detect the state information of the network (S620). Then, the information server may provide a network state information response message including the detected network state information to the terminal (S630). In this case, the information server may exchange request and response messages with the terminal through an REST API. In particular, the network state information response message may transmit the network state information in an XML or JSON format.

As another example, when the information server detects the state information of the network (S620), it may select an optimal network for the terminal and provide the optimal network selection result to the terminal (S630).

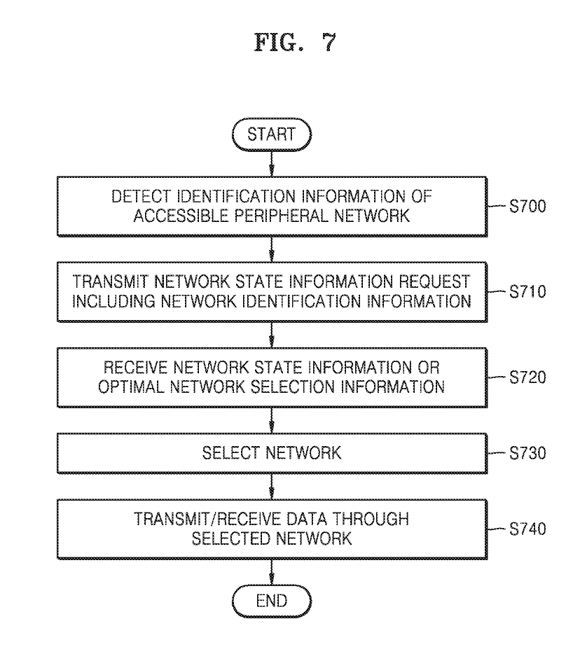

FIG. 7 is a diagram illustrating an example of a multiple wireless network integration method in a terminal according to the present disclosure.

Referring to FIG. 7, the terminal may detect identification information of an accessible peripheral network (S700). The terminal may transmit a network state information request message including the network identification information to the information server (S710). When receiving network state information from the information server (S720), the terminal may select an optimal network based on the network state information (S730). Then, the terminal may transmit/receive data through the selected network (S740). The terminal may perform the optimum network selection process of FIG. 7 on a flow-by-flow basis. When there are a plurality of optimal networks selected for each flow, that is, when a first network is selected for a first flow and a second network is selected for a second flow, the terminal may transmit/receive a packet of the first flow and a packet of the second flow in parallel through the first and second networks.

As another example, the terminal may skip the optimal network selection process (S730) by receiving the optimum network selection result from the information server or the SDN controller, instead of the network state information.

The present disclosure may also be embodied as computer-readable codes on a computer-readable recording medium. The computer readable recording medium may be any data storage device that may store data that may be thereafter read by a computer system. Examples of the computer-readable recording medium may include read-only memories (ROMs), random-access memories (RAMs), compact disk read-only memories (CD-ROMs), magnetic tapes, floppy disks, and optical data storage devices. The computer-readable recording medium may also be distributed over network-coupled computer systems so that the computer-readable codes may be stored and executed in a distributed fashion.

The present disclosure has been particularly shown and described with reference to the embodiments thereof. However, those of ordinary skill in the art will understand that various changes in form and details may be made therein without departing from the spirit and scope of the present disclosure as defined by the appended claims. Therefore, the described embodiments should be considered in descriptive sense only and not for purposes of limitation. Thus, the scope of the present disclosure may be defined not by the above descriptions but by the appended claims, and all differences within the equivalent scope thereof will be construed as being included in the present disclosure.

1. A multiple wireless network integration system comprising:
a software defined network (SDN) switch connected to at least two or more networks to monitor traffic information of each network;
an SDN controller providing the SDN switch with forwarding table information generated by using packet information received from the SDN switch and receiving the traffic information of each network from the SDN switch to generate high-level traffic information; and
an information server receiving the high-level traffic information from the SDN controller to generate network state information and providing a terminal with a plurality of network state information accessible to the terminal or optimal network selection information detected based on the plurality of network state information.

2. The multiple wireless network integration system of claim 1, wherein the at least two or more networks comprise a femtocell and a Wireless Fidelity (WiFi) network.

3. The multiple wireless network integration system of claim 1, wherein the SDN switch is located in a local network or a mobile communication network.

4. The multiple wireless network integration system of claim 1, wherein the SDN controller generates the high-level traffic information by using the traffic information received from the SDN switch and provides the generated high-level traffic information to the information server.

5. The multiple wireless network integration system of claim 1, wherein the information server provides the plurality of network state information to the terminal by using a Representational State Transfer (REST) Application Program Interface (API).

6. The multiple wireless network integration system of claim 5, wherein the information server provides the plurality of network state information or the optimal network selection information to the terminal in an eXtensible Markup Language (XML) or JavaScript Object Notation (JSON) format.

7. A terminal for multiple wireless network integration, the terminal comprising:
a network state information receiving unit requesting and receiving optimal network selection information or state information about a plurality of available networks from an information server;
a network selecting unit selecting one of the plurality of networks based on the optimal network selection information or the network state information; and
an interface unit transmitting/receiving packets through the selected network on a flow-by-flow basis.

8. The terminal of claim 7, wherein the network state information receiving unit searches a peripheral access point to detect identification information of a plurality of available networks, and requests and receives state information of each network from the information server by using the identification information of the network.

9. The terminal of claim 7, wherein the network state information receiving unit requests and receives the network state information or the optimal network selection information from the information server through a Representational State Transfer (REST) Application Program Interface (API).

10. The terminal of claim 8, wherein the network state information receiving unit receives the network state information or the optimal network selection information in an eXtensible Markup Language (XML) or JavaScript Object Notation (JSON) format.

11. A method for multiple wireless network integration in a software defined network (SDN) switch connected to a plurality of networks, the method comprising:
switching packets received from the plurality of networks based on forwarding table information received from an SDN controller;
monitoring traffic information about each of the plurality of networks; and
transmitting the traffic information to the SDN controller.

12. The method of claim 11, wherein the SDN switch is located in a local network or a mobile communication network.

13. The method of claim 11, wherein the monitoring comprises detecting the traffic information including the number of transmitted/received packets, the number of lost packets, and the number of packets with errors with respect to each network.

14. A method for multiple wireless network integration in an information server providing state information of a plurality of networks, the method comprising:
receiving high-level traffic information from a software defined network (SDN) controller generating the high-level traffic information by using traffic information monitored through an SDN switch;
generating network state information by using the high-level traffic information received from the SDN controller or generating optimal network selection information for a terminal based on the network state information; and
providing the terminal with the optimal network selection information or state information about at least two or more networks accessible to the terminal.

15. The method of claim 14, wherein the providing comprises:
receiving at least one or more network identification information from the terminal; and
providing the terminal with the optimal network selection information or network state information detected based on the network identification information.

16. The method of claim 14, wherein the providing comprises providing the terminal with the network state information or the optimal network selection information in an eXtensible Markup Language (XML) or JavaScript Object Notation (JSON) format through a Representational State Transfer (REST) Application Program Interface (API).

17. A method for multiple wireless network integration in a terminal connectable to at least two or more networks, the method comprising:
detecting a plurality of accessible network identification information;
transmitting a network state information request including the network identification information to an information server and receiving network state information or optimal network selection information from the information server;
selecting one of a plurality of accessible networks with respect to each flow based on the network state information or the optimal network selection information; and
transmitting/receiving packets through the selected network on a flow-by-flow basis.

18. The method of claim 17, wherein the transmitting of the network state information request and the receiving of the network state information or the optimal network selection information are performed through a Representational State Transfer (REST) Application Program Interface (API), and the network state information or the optimal network selection information is formatted in an eXtensible Markup Language (XML) or JavaScript Object Notation (JSON) format.

19. A computer-readable recording medium having recorded thereon a program for performing the method of claim 11.
